(19) United States
(12) Patent Application Publication
(10) Pub. No.: US 2006/0021231 A1
(43) Pub. Date: Feb. 2, 2006

(54) Adaptive scissors

(76) Inventor: Nancy Davidson Carey, Union, OH (US)

Correspondence Address: Joseph G. Nauman, 696 Renolda Woods Ct., Dayton, OH, 45429-3415, US

(21) Appl. No.: 11/185,553

(22) Filed: Jul. 20, 2005

Related U.S. Application Data
(60) Provisional application No. 60/591,853, filed on Jul. 28, 2004.

(51) Int. Cl. B26B 13/00

(52) U.S. Cl. 30/194

(57) ABSTRACT

In accordance with this invention, an underside or lower scissors handle, which is conventionally attached to the upper blade of a pair of scissors, is provided with a separate, appropriately sized, additional hole or loop-like band for receiving the index finger of the user. This additional index finger hole is located forward of the main lower finger opening. This unique placement of a separate index finger hole, which is a primary feature of this invention, isolates the index finger against the shaft of the scissors and closer to the pivot point of the blades, and allows the index finger to guide advancing motion of the scissor blades to the right or left as needed to follow a desired path or pattern, for example forming or following a curve. A separate third hole for placement of the index finger makes these scissors unique. Isolating the index finger against the shaft of the scissor handle provides stability and strength and allows the index finger to adjust or “guide” the scissors to the left or right making easy and very subtle adjustments as needed to negotiate curves and angles as in following a pattern. Another feature relates to the “thumb hole” in the upper handle. The inner diameter of such upper handle thumb hole is limited with a suitable restraint, such that the thumb enters only by an amount sufficient to keep the thumb in flexion, and not far enough to place the thumb in extension.

### PRIOR APPLICATION

This application claims the priority of and is based upon, and hereby incorporates by reference the entire disclosure of, U.S. Provisional Application for ADAPTIVE SCISSORS, U.S. Ser. No. 60/591,853 filed 28 Jul. 2004.

### BACKGROUND OF THE INVENTION

This invention relates to the creation and placement of finger and thumb holes in the handles of scissors. For purposes of this invention, the lower handle is part of the upper blade and the holes in the lower handle are deemed the finger hole or holes, the upper handle is part of the lower blade, and a thumb hole is formed in the upper handle. These handles are attached by a suitable pivot, whereby manipulation of the handles toward and away from each other causes corresponding opening and closing action of the blades.

### BACKGROUND OF THE INVENTION

With standard scissors many users, including younger children who are learning (or being taught) to cut with scissors, place their index finger in the elongated hole of the underside of the handle, along with one or more additional fingers of the same hand. In the literature devoted to teaching and/or reinforcing skills involving use of scissors (or related motor skills) there are repeated recommendations that the index finger of the predominant hand, more often the right hand, be placed below the scissor blade ahead of the lower handle loop, and the middle finger(s) be placed in that loop. In fact, some prior art scissors provide a short forward opening feature on the exterior of the lower handle loop.

The tendency not to do so has been observed by teachers and therapists, and often happens with children even when they are verbally prompted to keep the index finger outside that elongated hole, even when the above-mentioned feature is included in the handle. It appears they intuitively relapse to placing the index finger along with one or more other fingers into the lower handle loop. This creates a situation wherein movements of the user's wrist direct the scissors to the left or right. These movements are larger, with more subtle adjustment, i.e. for detail work, cutting at sharp angles, or the like being much more difficult to achieve.

Also younger, smaller, children tend to insert their thumb too far into the thumb hole of the scissors upper handle, thereby placing their thumb in extension and narrowing the web between the thumb and the side of the hand. This thumb placement reduces the leverage that can be applied to open and close the scissors.

### SUMMARY OF THE INVENTION

In accordance with this invention, an underside or lower scissors handle, which is conventionally attached to the upper blade of a pair of scissors, is provided with a separate, appropriately sized, additional hole or loop-like band for receiving the index finger of the user. This additional index finger hole is located forward of the main lower finger opening. This unique placement of a separate index finger hole, which is a primary feature of this invention, isolates the index finger against the shaft of the scissors and closer to the pivot point of the blades, and allows the index finger to guide advancing motion of the scissor blades to the right or left as needed to follow a desired path or pattern, for example forming or following a curve.

A separate third hole for placement of the index finger makes these scissors unique. Isolating the index finger against the shaft of the scissor handle provides stability and strength and allows the index finger to adjust or “guide” the scissors to the left or right making easy and subtle adjustments as needed to negotiate curves and angles as in following a pattern. Otherwise, with standard scissors many children place the index finger in the large loop along with one or more of the middle fingers and do not achieve the desired action. In so doing, they tend to extend the index finger out rather than maintaining it on the shaft of the scissor handle. This incorrect placement creates a situation where movements of the wrist adjust the scissors. These movements are bigger, making subtle adjustments for cutting detail work, angles, and curves more difficult, and typically not very accurate in reference to the cutting line.

Another feature of the invention relates to the “thumb hole” in the upper handle, which normally receives the thumb of the user's hand. In accordance with this other feature of the invention, the inner diameter of such upper handle thumb hole is limited with a suitable restraint, such that the thumb enters only by an amount sufficient to keep the thumb in flexion, and not far enough to place the thumb in extension. This maintains flexibility of the “web space” between the thumb and the side of the hand, and allows for greater leverage when opening and closing the scissors; if the thumb is held in extension, leverage is substantially reduced. The requisite reduction in thumb hole diameter can be readily achieved by partially filing the thumb hole with a predetermined amount of padding, i.e. a covered ring of foam or an equivalent device, added to the thumb hole. The exact amount of restriction will depend upon the size of a user's outer thumb joint, but it should be sufficient to impede thumb thrust into and through the thumb hole.

Other objects and advantages of the invention will be apparent from the following description and the accompanying drawings.

### BRIEF DESCRIPTION OF THE DRAWINGS

FIG. 1 is a frontal view of a scissors incorporating the features of the invention;

FIG. 2 is a rear or back view of the scissors shown in FIG. 1;

FIG. 3 is an edge view of the scissors shown in FIG. 1, as seen from the edge of the thumb or upper portion of the handle;

FIG. 4. is an opposite edge view of the scissors shown in FIG. 1, as seen from the edge of the elongated or finger portion of the handle;

FIG. 5 is a view similar to FIG. 2, with the addition of a restrictive pad in the thumb hole;

FIG. 6 is a partial view of the upper portion of the handle, illustrating a flexible cup inserted in the thumb hole to achieve the requisite restriction of thumb entry; and

FIG. 7 is a perspective view of another embodiment of scissors, with the blades foreshortened, and the extra index finger hole molded into the lower handle forward of the elongated finger aperture.

### DESCRIPTION OF PREFERRED EMBODIMENT

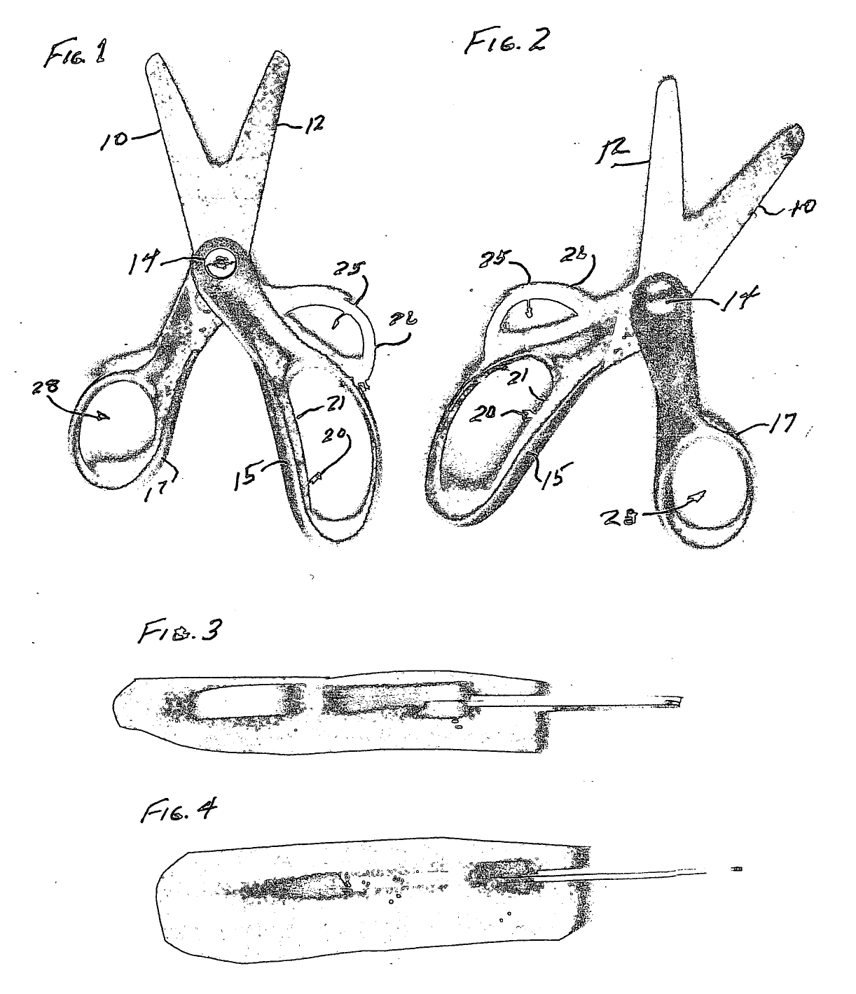

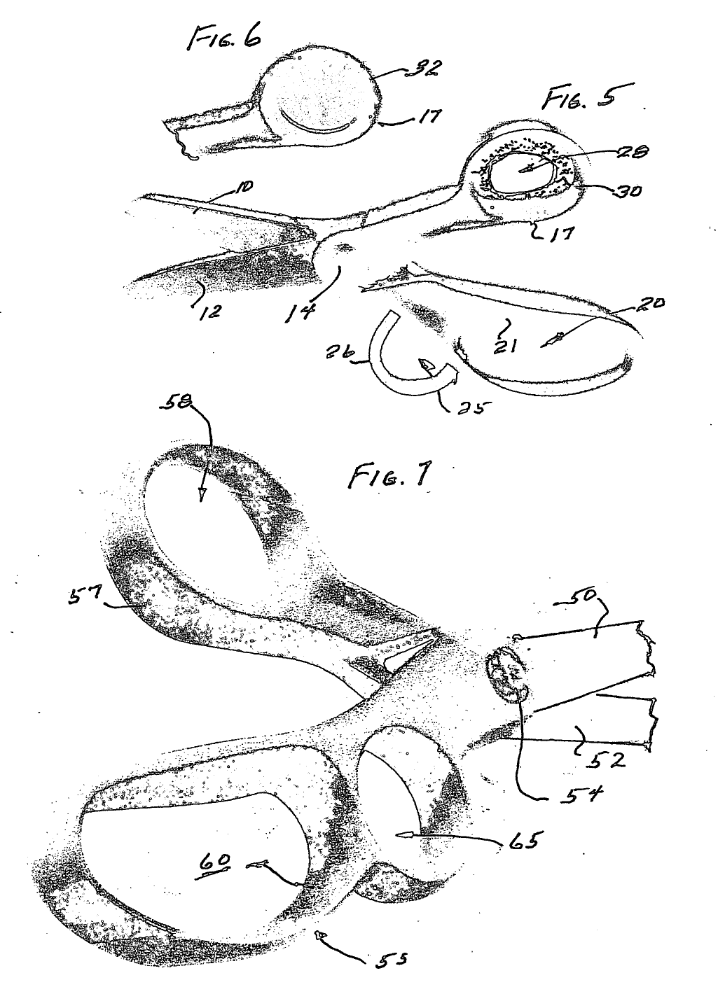

Referring to FIGS. 1 and 2, a scissors tool according to the present invention includes an upper blade 10 and lower blade 12, connected by a hinge pin 14 providing a pivot means for opening a closing action of the blades. The forward end of the blades forms the forward tip of the scissors. A handle at the rear end of the scissors comprises a lower handle part 15 attached to blade 10 and an upper handle part 17 attached to blade 12, both extending rearward from hinge pin 14. Lower handle part 15 is provided with an elongated aperture 20 of generally oval shape, and (as in most instances) including a flattened interior surface 21 in the region where the grips or handle parts 15,17 come together when the blades are closed.

On the forward end of lower handle part 15 there is a smaller secondary aperture 25 defined by a generally U-shaped ring or band 26 that is attached at its ends into the exterior forward sides of lower handle 15. This aperture 25 assures a separate locating function for the index finger of the user, for reasons set forth above. It has been discovered that in a training environment, an aperture is the best effective construction to achieve this result, especially in training smaller children or handicapped persons. An arcuate formation on the front of the forward outside edge of the lower handle part 15 (e.g. ahead of the aperture 20,) does not properly confine the index finger of a user, as is necessary according to the invention.

For purposes of ease of manufacturing the fabricated material (e.g. a cord) ring 26 may be flexible and (optionally) of such length as to function as a form of draw-string for adjusting the cross-sectional size of aperture 25 to the finger size of the user. This specific feature is not considered a necessary element of the present invention, and such adjustability is at best an optional function.

Upper handle part 17 includes a “thumb hole” aperture 28 into which the user can place only a limited extent of the end of his thumb. In accordance with the invention, aperture 17 may have a reduced size (relative to the other apertures) in its original manufacture, or may be restricted by a ring-like pad 30 (FIG. 5) to prevent the user from pushing the thumb interphalangeal joint into aperture 28, for the reason set forth above. Pad 30 may be formed of dense foam or comparable pliable but firm material. Other devices for restricting the length of insertion of the thumb into aperture 28 can be used, such as the flexible cup 32 shown in FIG. 6.

FIG. 7 illustrates another form of scissors utilizing the index finger placement aperture of the invention. In this drawing, like parts are given comparable numbers beginning with numeral 5; i.e. upper blade 50, lower blade 52, pivot pin 54, lower handle part 55, upper handle part 57, oval shaped aperture 60, etc. In this embodiment the index finger (secondary) aperture 65 is provided as an integral molded extension 66 formed forwardly of the lower handle part 55.

While the forms of apparatus herein described constitute preferred embodiments of this invention, it is to be understood that the invention is not limited to these precise forms of apparatus, and changes may be made therein without departing from the scope of the invention.

What is claimed is:

1. An adaptive scissors comprising an upper blade member and a lower blade member each having a sharpened forward end and a rearward end and pivotally attached to each other for opening and closing motion of the sharpened forward ends of the blades so as to cut material through which the scissors is passed,
handles at the rearward ends of said blades and comprising a lower handle part attached to said upper blade member and an upper handle part attached to said lower blade member, said handle parts being movable toward each other when said blades are closed and moving apart as the blades are separated to be advanced with respect to the material,
said upper handle part having an aperture for reception of the thumb of a user's hand,
said lower handle part having an elongated aperture of generally oval shape to receive at least one finger of the user's hand other than the index finger, and
a smaller secondary aperture on said lower handle part at the front of said lower handle part providing a separate locating aperture for surrounding the index finger of the user's hand to train the user to place the index finger of his/her hand forward of the lower handle part into which the other fingers are placed, and thus to enhance guidance of the scissors as it is moved forward through material being cut.

2. A scissors as defined in claim 1, further comprising
a stop member located in said upper handle aperture to limit the extension of a user's thumb into said upper handle aperture.

3. A scissors as defined in claim 1, further comprising
a flexible band secured to said lower handle part as a loop at the front thereof to define said separate locating aperture.

4. A scissors comprising an upper blade and a lower blade,
pivot means connecting said blades for opening and closing motion so as to cut material positioned between said blades,
said blades having forward tips which can be closed and opened forward of said pivot means,
a handle at the rear end of said blades comprising a lower handle part attached to said upper blade and an upper handle part attached to said lower blade, both said handle parts extending rearward from said pivot means,
said upper handle part having an aperture for reception of the thumb of a user.
said lower handle part having an elongated aperture of generally oval shape and also including a flattened interior surface in the region where the handle parts come together when the blades are closed, and
a smaller secondary aperture defined by a generally oval band extending from the exterior forward sides of said lower handle part and providing a separate locating aperture for the index finger of the user so as to isolate the index finger against the side of the scissors and close to the pivot point of the blades, allowing the index finger to guide the scissor blades to the right or left as needed to follow a desired path.

5. A scissors as defined in claim 4, further comprising said upper handle aperture being sized to limit the extension of a thumb into said upper handle aperture.

6. A scissors as defined in claim 5, wherein a stop member is located in said upper handle aperture to limit the size of the passage therethrough.

7. A scissors as defined in claim 4, further comprising
said band defining said separate locating aperture is a flexible member which can be adjusted in length to provide a control of the aperture size of said separate locating aperture.
